(19) United States
(12) Patent Application Publication
(10) Pub. No.: US 2025/0115411 A1
(43) Pub. Date: Apr. 10, 2025

(54) MEDICATION PILL DISPENSER

(71) Applicant: David Davidson, Rancho Cucamonga, CA (US)

(72) Inventor: David Davidson, Rancho Cucamonga, CA (US)

(21) Appl. No.: 18/990,903

(22) Filed: Dec. 20, 2024

Related U.S. Application Data
(63) Continuation-in-part of application No. 18/544,969, filed on Dec. 19, 2023.
Application No. 18/544,969 is a continuation of application No. 18/051,839, filed on Nov. 1, 2022, now Pat. No. 11,884,474.

(51) Int. Cl. B65D 83/04; G04B 47/04

(52) U.S. Cl. CPC B65D 83/0409; G04B 47/04; B65D 2583/0436; B65D 2583/0459; B65D 2583/0463

(57) ABSTRACT

A product dispensing clock includes a housing and a reservoir arranged in the housing. The reservoir holds a number of dispensable products. A dispenser is arranged in the housing adjacent the reservoir. The dispenser receives at least one of the dispensable products from the reservoir. A collection chamber is defined in the housing. The dispenser dispenses the dispensable products received from the reservoir to the collection chamber for a user to collect the dispensable products. A controller activates the dispenser at a predetermined time interval to dispense the dispensable products to the collection chamber for collection by the user.

### CROSS-REFERENCE TO RELATED APPLICATIONS

This application is a continuation in part application of U.S. Ser. No. 18/544,969, filed on 2023 Dec. 19, which is a continuation application of U.S. application Ser. No. 18/051,839, now U.S. Pat. No. 1,184,474, filed on 2022 Nov. 1, the entire contents of which are expressly incorporated herein by reference.

### FIELD

The present disclosure relates to a clock and, more particularly, to a product dispensing clock.

### BACKGROUND

A calendar is a system for keeping track of days, weeks, and months. Calendars can be used to count down an amount of time remaining before an event will occur. For example, a number of days remaining before an event will occur can be tracked by using a calendar and noting each passing day. However, users of a calendar to count down days to an event may lose interest in the calendar and therefore lose track of how many days remain before the event. This may occur as a result of boredom or declining interest in the calendar, and thus the number of days remaining before an upcoming event may become unclear.

### SUMMARY

A product dispensing clock can dispense a surprise every day after being loaded by a user with desired dispensable products. For example, a product may be dispensed once per day every day for 15 days leading up to an event. The product dispensing clock can be filled with candy, or any other small item that is desired. Holding balls can be included and each of the holding balls can be loaded with the desired dispensable product.

The product dispensing clock can be changed to suit different events. For example, different clothing or accessories can be added to or removed from the product dispensing clock for different occasions or events.

The product dispensing clock can be hung on a wall or positioned on a shelf or other furniture.

A user can get excited about upcoming events each time a product is dispensed by the product dispensing clock. The user can be reminded about an exciting upcoming event each day leading up to the event.

Provided in accordance with aspects of the present disclosure is a dispensing clock including a housing and a reservoir arranged in the housing. The reservoir holds a number of dispensable products. A dispenser is arranged in the housing adjacent the reservoir. The dispenser receives at least one of the dispensable products from the reservoir. A collection chamber is defined in the housing. The dispenser dispenses the dispensable products received from the reservoir to the collection chamber for a user to collect the dispensable products. A controller activates the dispenser at a predetermined time interval to dispense the dispensable products to the collection chamber for collection by the user.

In an aspect of the present disclosure, storage vessels each include a first portion and a second portion removably coupled with the first portion. Each of the storage vessels is configured to hold at least one dispensable product.

In an aspect of the present disclosure, each of the storage vessels defines a spherical shape.

In an aspect of the present disclosure, the controller includes a computer having a processor and a memory. The memory stores computer instructions executable by the processor to activate the dispenser at the predetermined time interval.

In an aspect of the present disclosure, a time keeping module is configured to control time keeping hands. The controller receives time data from the time keeping module.

In an aspect of the present disclosure, the reservoir is arranged as a conduit connecting a loading orifice with the dispenser.

In an aspect of the present disclosure, the conduit defines a curved shape configured to advance the dispensable products by a force of gravity.

In an aspect of the present disclosure, a storage chamber is defined in the housing. The storage chamber is configured to store the dispensable product. The storage chamber is in communication with the reservoir.

In an aspect of the present disclosure, the predetermined time interval is once per day.

In an aspect of the present disclosure, the dispenser includes a holding chamber and an orifice configured to pass the dispensable products into the collection chamber from the reservoir.

In an aspect of the present disclosure, the dispenser is configured to rotate to dispense the dispensable products received from the reservoir to the collection chamber.

In an aspect of the present disclosure, a motor rotates the dispenser.

In an aspect of the present disclosure, a battery powers the controller.

In an aspect of the present disclosure, an AC or DC jack is configured to receive a power adapter to deliver power to the controller.

In an aspect of the present disclosure, a mechanical clock or a digital clock is in communication with the controller. The controller receives time data from the mechanical clock or the digital clock.

In an aspect of the present disclosure, the controller is programmable to set the predetermined time interval.

In an aspect of the present disclosure, the housing includes a first housing component and a second housing component separable from the first housing component.

In an aspect of the present disclosure, the collection chamber is supported between the first housing component and the second housing component.

In an aspect of the present disclosure, the first housing component defines a first portion of the reservoir and the second housing component defines a second portion of the reservoir.

In an aspect of the present disclosure, the controller includes a circuit board in electrical communication with a motor. The motor drives the dispenser to dispense the dispensable products to the collection chamber for collection by the user.

### BRIEF DESCRIPTION OF THE DRAWINGS

Various aspects and features of the present disclosure are described hereinbelow with reference to the drawings wherein:

FIG. 1 is an exploded, perspective view of a dispensing clock according to aspects of the present disclosure;

FIG. 2A is a front view of a front housing of the product dispensing clock of FIG. 1;

FIG. 2B is a rear view of the front housing of the product dispensing clock of FIG. 1;

FIG. 2C is a side view of the front housing of the product dispensing clock of FIG. 1;

FIG. 2D is a top plan view of the front housing of the product dispensing clock of FIG. 1;

FIG. 3A is a rear view of a rear housing of the product dispensing clock of FIG. 1;

FIG. 3B is a front view of the rear housing of the product dispensing clock of FIG. 1;

FIG. 3C is a side view of the rear housing of the product dispensing clock of FIG. 1;

FIG. 3D is a top plan view of the rear housing of the product dispensing clock of FIG. 1;

FIG. 4A is a top plan view of a dispenser of the product dispensing clock of FIG. 1;

FIG. 4B is a perspective view of the dispenser of the product dispensing clock of FIG. 1;

FIG. 4C is a cross-sectional view of the dispenser of the product dispensing clock of FIG. 1;

FIG. 4D is a side view of the dispenser of the product dispensing clock of FIG. 1;

FIG. 5A is a top plan view of a first portion of a storage vessel of the product dispensing clock of FIG. 1;

FIG. 5B is a perspective view of the first portion of the storage vessel of the product dispensing clock of FIG. 1;

FIG. 5C is a first side view of the first portion of the storage vessel of the product dispensing clock of FIG. 1;

FIG. 5D is a second side view of the first portion of the storage vessel of the product dispensing clock of FIG. 1;

FIG. 6A is a top plan view of a second portion of the storage vessel of the product dispensing clock of FIG. 1;

FIG. 6B is a perspective view of the second portion of the storage vessel of the product dispensing clock of FIG. 1;

FIG. 6C is a first side view of the second portion of the storage vessel of the product dispensing clock of FIG. 1;

FIG. 6D is a second side view of the second portion of the storage vessel of the product dispensing clock of FIG. 1;

FIG. 7 is a block diagram of an exemplary computer employable by the device, system, and method described herein according to aspects of the present disclosure.

FIG. 8 is an exploded, perspective view of a dispensing clock according to aspects of the present disclosure for dispensing medication pills having a removably insertable reservoir;

FIG. 9 is a top perspective view of a dispenser of the product dispensing clock of FIG. 8;

FIG. 10 is a top perspective view of a storage vessel of the product dispensing clock for containing medication pills; and

FIG. 11 is a block diagram of an exemplary computer employable by the device, system, and method described herein according to aspects of the present disclosure.

### DETAILED DESCRIPTION

A product dispensing clock 100 is disclosed herein. The clock 100 can be programmed to release a product 103 periodically (e.g., the same time every day) for a preset number of days. For example, in the lead up to Christmas, the clock 100 can dispense one product 103 every morning at 8 am. To accomplish the same, the clock 100 may have a reservoir 102 which holds a plurality of storage vessels 107. One product 103 may be encased or held within each storage vessel 107. The storage vessels 107 are lined up in the reservoir 102 and one storage vessel 107 is disposed within the holding chamber 113 of the dispenser 104. At the programmed time, a controller 106 activates a motor 114 to rotate the dispenser 104 one revolution in the counterclockwise direction. The one storage vessel 107 which was disposed in the holding chamber 113 is dropped into the collection chamber 105. The dispenser 104 continues to rotate and when the holding chamber 113 is aligned underneath an exit 131 of the reservoir 102, the bottom most storage vessel 107 in the reservoir 102 is then gravity fed into the holding chamber 113 to be dispensed during the next rotational cycle of the dispenser 104.

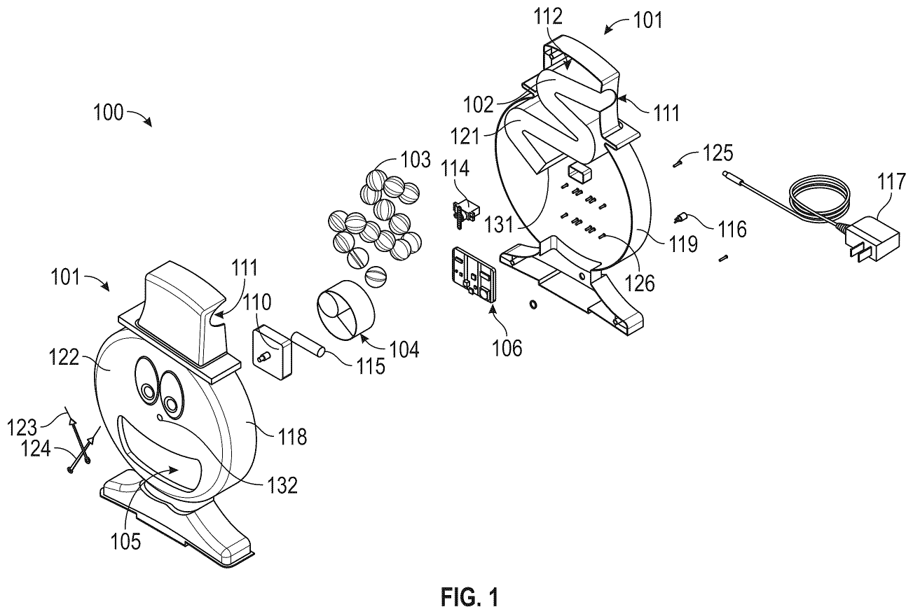

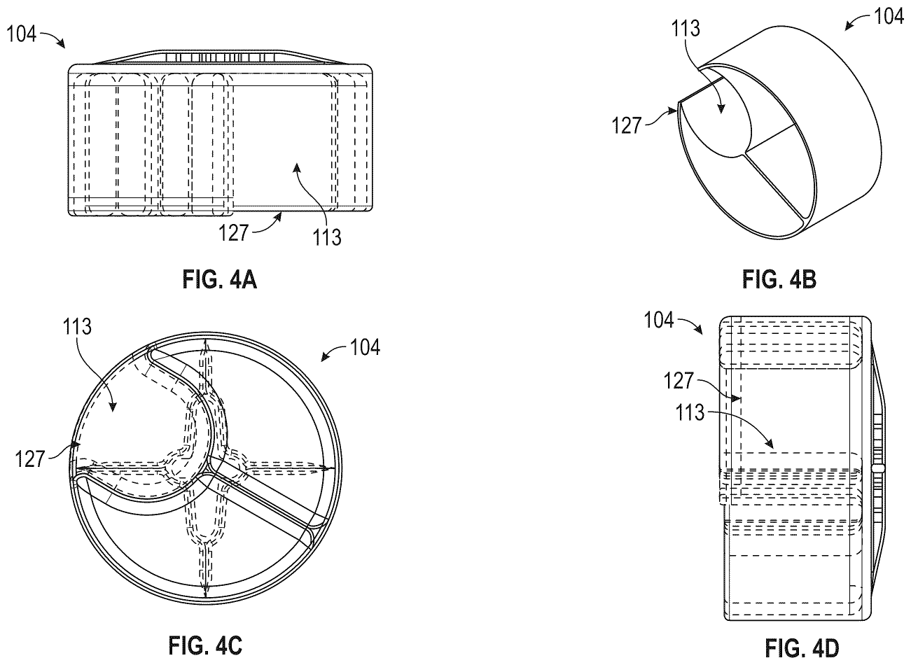

Referring to FIG. 1, a product dispensing clock 100 includes a housing 101 and a reservoir 102 arranged in the housing 101. The reservoir 102 holds a number of dispensable products 103. A dispenser 104 (see, e.g., FIGS. 1 and 4B) is arranged in the housing 101 adjacent the reservoir 102. The dispenser 104 receives at least one of the dispensable products 103 from the reservoir 102. The reservoir 102 is arranged as a conduit connecting a loading orifice 111 defined at an upper portion of the housing 101 with the dispenser 104. The reservoir 102 may define a curved shape configuration to advance the dispensable products 103 by a force of gravity.

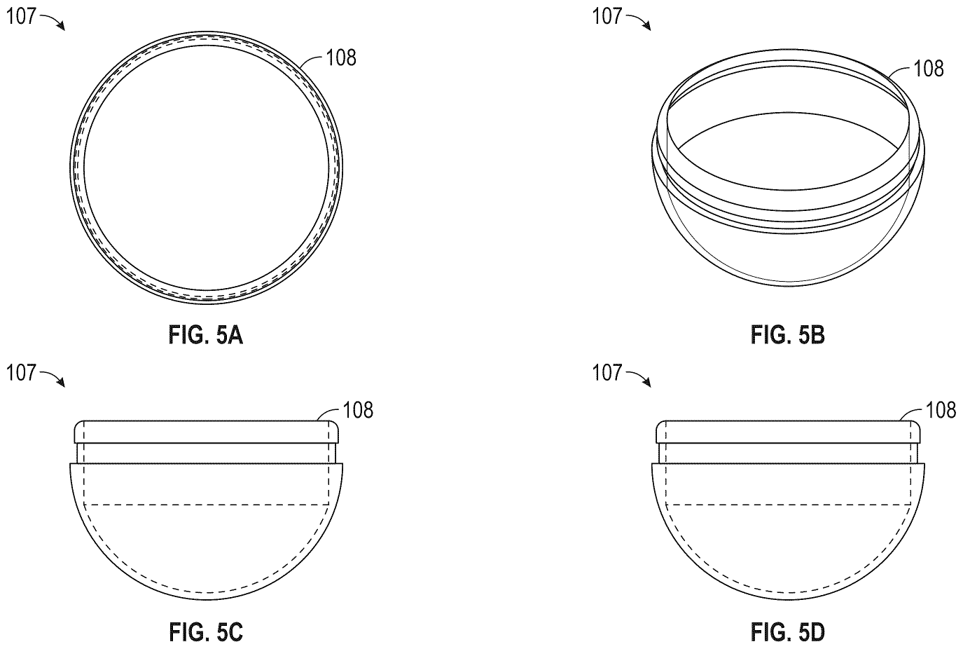

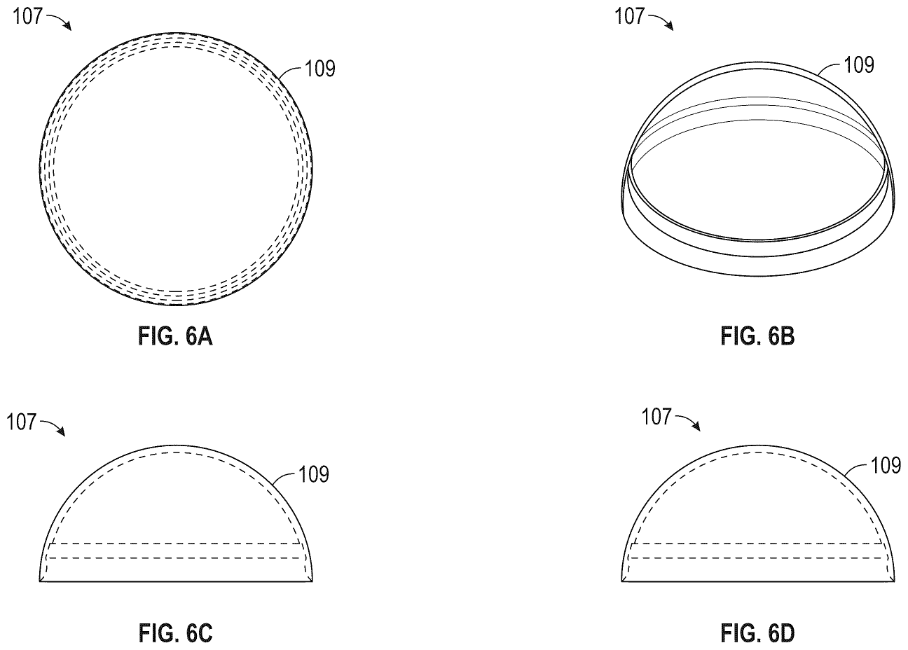

The dispensable products 103 may be loaded into storage vessels 107 (see, e.g., FIGS. 5A to 6D). The dispensable products 103 and the storage vessels 107 are shaped and dimensioned to fit through the loading orifice 111 and to be arranged in-line with each other within the reservoir 102 so that the dispensable products 103 and the storage vessels 107 will advanced downwardly through the reservoir 102 and toward the dispenser 104 by the act of gravity alone. This arrangement of the dispensable products 103 and the storage vessels 107 in the reservoir 102 allows the dispensable products 103 to de dispensed one at a time.

A collection chamber 105 is defined in the housing 101. The dispenser 104 dispenses the dispensable products 103 received from the reservoir 102 to the collection chamber 105 for a user to collect the dispensable products 103. As an example, the collection chamber 105 may be an opening in a front side 122 of the housing 101.

A controller 106 activates a motor 114 which rotates the dispenser 104 a predetermined angular rotation and at a predetermined time interval to dispense the dispensable products 103 to the collection chamber 105 for collection by the user.

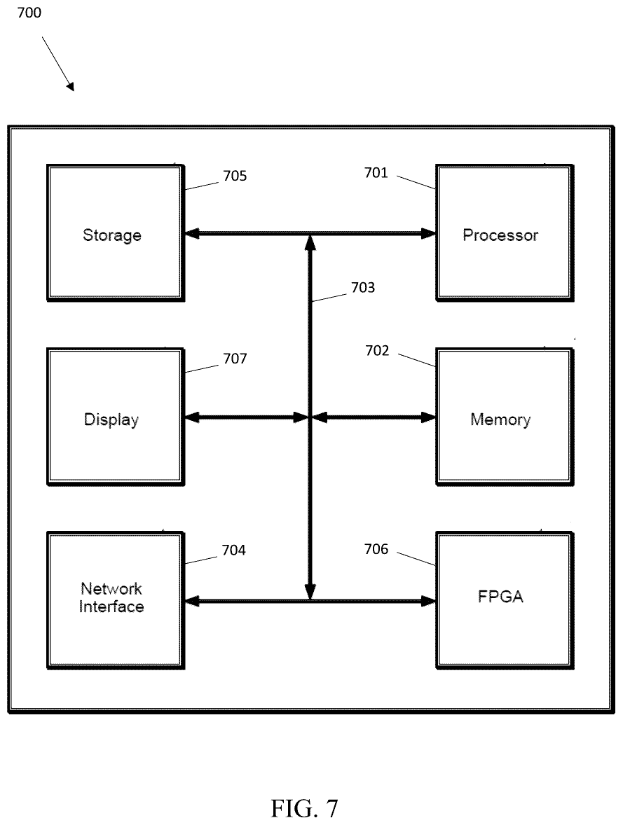

The controller 106 may include a computer 700 (see, e.g., FIG. 7 described in more detail below) having a processor 701 and a memory 702. The memory 702 stores computer instructions executable by the processor 701 to activate the dispenser 104 at the predetermined time interval. The controller 106 may include a circuit board in electrical communication with motor 114 and configured to activate the motor 114 to drive the dispenser 104 (e.g., to rotate the dispenser 104).

The components of the product dispensing clock 100 (e.g., the controller 106, the time keeping module 110, and/or the motor 114) may be powered by a battery 115, such as a rechargeable battery. As an example, the battery 115 may be an alkaline battery, a nickel metal hydride battery, or a lithium ion battery. Alternatively, or in conjunction with use of the battery 115, the components of the product dispensing clock 100 may be powered by an AC or DC jack 116 configured to receive electrical power form a power adapter 117.

In an aspect of the present disclosure, the product dispensing clock 100 includes a time keeping module 110 configured to control time keeping hands (see, e.g., time keeping hands 123 and 124 in FIG. 1). The time keeping hands can be used to display a time to a user of the product dispensing clock 100. The time keeping hands may include, hour, minute, and second hands. A digital display may also be employed to communicate the time of day to a user of the product dispensing clock 100. The controller 106 receives time data from the time keeping module 110 to determine when it is time to dispense a dispensable product 103. As an example, a mechanical clock or a digital clock may be in communication with the controller 106. The controller 106 may receive the time data from the mechanical clock or the digital clock.

In use, the product dispensing clock 100 is loaded with desired dispensable products 103. The dispensable products 103 are generally loaded into the storage vessels 107, and the storage vessels 107 including the dispensable products 103 can then be loaded into the product dispensing clock 100 by using the storage vessels 107 that are holding the dispensable products 103. The time at which the product dispensing clock 100 will dispense the dispensable products 103 can be custom programmed by a user. When the product dispensing clock 100 is first set up, the product dispensing clock 100 will dispense a first product relatively quickly (e.g., between 1 to 300 seconds) after the product dispensing clock 100 is programmed to confirm that the product dispensing clock 100 is on and successfully programmed. The product dispensing clock 100 will then dispense one of the dispensable products 103 each day leading up to an event. For example, the product dispensing clock 100 may be programmed to dispense one of the dispensable products 103 at the same time each day for 15 days leading up to an event. However, the daily time at which one of the dispensable products 103 is dispensed and the number of days for which a dispensable product 103 will be dispensed can be programmed, as desired.

The spherical shape of the storage vessels 107 facilitates gravity feeding of the storage vessels 107 through the reservoir 102. However, in the case of a dispensable product 103 that is shaped and dimensioned to be gravity fed through the reservoir 102 without the use of the storage vessels 107, the storage vessels 107 may be omitted, and dispensable products 103 can be directly loaded into the reservoir 102 without the use of the storage vessels 107. For example, a spherical product, such as a toy ball can be loaded into the reservoir 102 without the use of the storage vessels 107. It is also contemplated that non-spherical dispensable products 103 can be loaded into the reservoir 102 without the use of the storage vessels 107 if the non-spherical dispensable products 103 are shaped and dimensioned to be gravity fed through the reservoir 102 without the use of the storage vessels 107.

The product dispensing clock 100 may be programmed by using a programmable button 132 that can be used to enter a series of commands entered using single taps, multiple taps, or holding the programmable button 132. For example, set the time, then set AM or PM to program the controller 106 to rotate the motor 114 to rotate the dispenser 104 one revolution so that one storage vessel 107 comes out at that time in the evening if PM was programmed or in the morning if AM Was programmed.

In an aspect of the present disclosure, the housing 101 includes a first housing component 118 and a second housing component 119 separable from the first housing component 118. As an example, a plurality of screws 125 may removably couple the first housing component 118 and the second housing component 119 to each other.

The collection chamber 105 may be supported between the first housing component 118 and the second housing component 119. For example, a plurality of pins 126 may extend from the first housing component 118 and/or the second housing component 119 to secure the collection chamber 105 below the dispenser 104.

In an aspect of the present disclosure, the first housing component 118 defines a first portion 120 of the reservoir 102 and the second housing component 119 defines a second portion 121 of the reservoir 102.

In an aspect of the present disclosure, a storage chamber 112 is defined in the housing 101. The storage chamber 112 is configured to store the dispensable product 103. The storage chamber 112 is in communication with the reservoir 102. The storage chamber 112 may be employed to increase the number of dispensable products 103 that can be stored within the housing 101. As an example, the reservoir 102 may hold from 1-15 dispensable products 103, and the storage chamber 112 may hold an additional 1-15 dispensable products 103 for loading into the reservoir 102 and to be dispensed by the dispenser 104.

Referring particularly to FIGS. 4A to 4D, the dispenser 104 includes a holding chamber 113 and an orifice 127 configured to pass the dispensable products 103 into the collection chamber 105 from the reservoir 102. In use, a single dispensable product 103 (e.g., a dispensable product 103 in a storage vessel 107) is transferred from the reservoir 102 and into the holding chamber 113 of the dispenser 104 through orifice 127 facing the reservoir 102 when the orifice 127 of the holding chamber 113 of the dispenser 104 is below and aligned to the exit 131 of the reservoir 102 for gravity feeding the storage vessel 107. Preferably, the orifice 127 of the holding chamber 113 of the dispenser 104 is below and aligned to the exit 131 of the reservoir 102 to promote the storage vessel 107 to drop into the holding chamber 113. During the day, people might jostle the clock 100 and thus promote the storage vessel 107 to drop into the holding chamber 113 if the storage vessel 107 was caught on an edge or protuberance. The dispensable product 103 is then transferred by the dispenser 104 and into the collection chamber 105. The dispensable product 103 can be dropped back through the orifice 127 and into the collection chamber 105 as a result of the force of gravity.

In an aspect of the present disclosure, the dispenser 104 is configured to rotate to dispense the dispensable products 103 received from the reservoir 102 to the collection chamber 105. As an example, a motor 114 rotates the dispenser 104 between a first position in which the orifice 127 faces the reservoir 102 and a second position in which the orifice 127 faces the collection chamber 105. The dispensable product 103 (e.g., a dispensable product in a storage vessel 107) is dropped through the orifice 127 and into the collection chamber 105 when the dispenser 104 is rotated to the second position. The dispenser 104 can then be rotated to a third position between the first position and the second position in which the orifice 127 does not face the reservoir 102 or the collection chamber 105. The controller 106 controls the dispenser 104 to rotate from the third position to the first position to collect another dispensable product 103 on or about the predetermined time interval (e.g., once per day).

Referring particularly to FIGS. 5A to 6D, the storage vessels 107 may each include a first portion 108 and a second portion 109 removably coupled with the first portion 108. Each of the storage vessels 107 is configured to hold at least one dispensable product 103. In use, a dispensable product 103 can be loaded into the first portion 108 and then the second portion 109 is removably coupled with the first portion 108 to hold the dispensable product 103 in the storage vessel 107 until it is collected by a user.

As an example, the first portion 108 may be removably secured to the second portion 109 by a snap fit connection.

In an aspect of the present disclosure, each of the storage vessels 107 defines a spherical shape.

Referring to FIG. 7, a general-purpose computer 700 employable by the controller 106 is described. The general-purpose computer 700 can be employed by the controller 106 to perform the various functions described herein. The computer 700 may include a processor 701 connected to a computer-readable storage medium or a memory 702 which may be a volatile type memory, e.g., RAM, or a non-volatile type memory, e.g., flash media, disk media, etc. The processor 701 may be another type of processor such as, without limitation, a digital signal processor, a microprocessor, an ASIC, a graphics processing unit (GPU), field-programmable gate array (FPGA), or a central processing unit (CPU).

In some aspects of the disclosure, the memory 702 can be random access memory, read-only memory, magnetic disk memory, solid state memory, optical disc memory, and/or another type of memory. The memory 702 can communicate with the processor 701 through communication buses 703 of a circuit board and/or through communication cables such as serial ATA cables or other types of cables. The memory 702 includes computer-readable instructions that are executable by the processor 701 to operate the computer 700 to execute the various functions described herein. The computer 700 may include a network interface 704 to communicate (e.g., through a wired or wireless connection) with other computers or a server. A storage device 705 may be used for storing data. The computer 700 may include one or more FPGAs 706. The FPGAs 706 may be used for executing various functions described herein. A display 707 may be employed to display data processed by the computer 700.

While a single dispensable product 103 is described in some examples herein as being dispensed (e.g., by using a storage vessel 107), the present inventive concept is not limited thereto, and multiple dispensable products 103 (e.g., multiple dispensable products 103 held in a storage vessel 107) can be dispensed at each predetermined time interval.

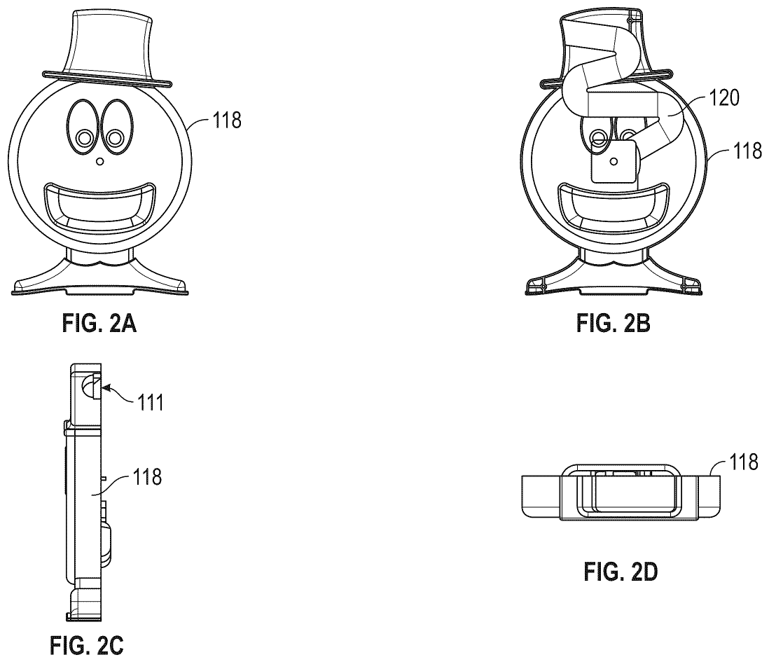

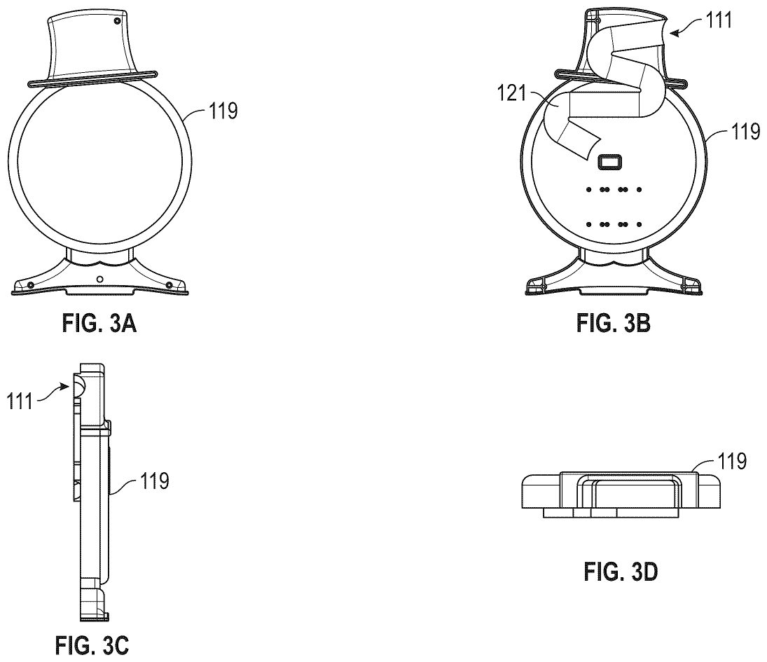

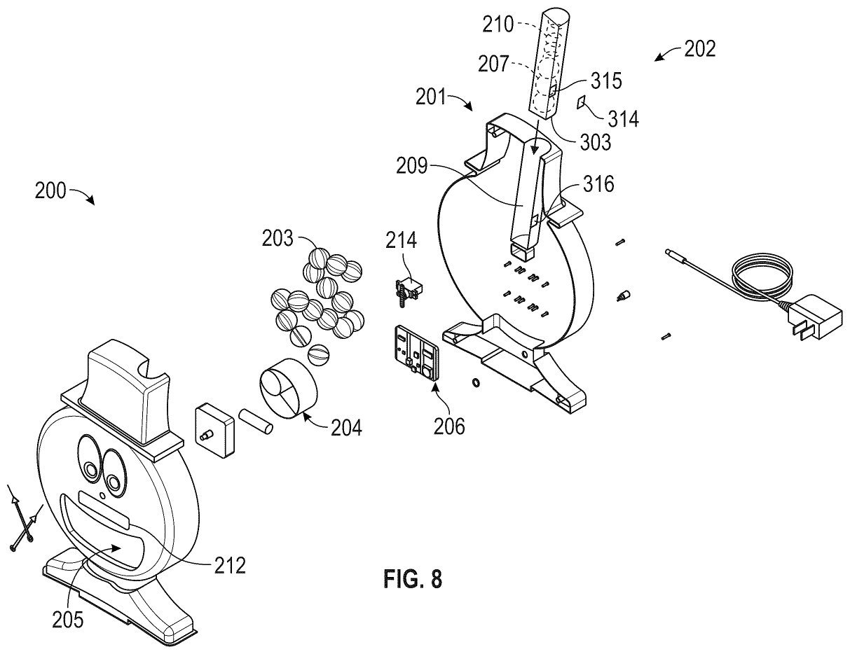

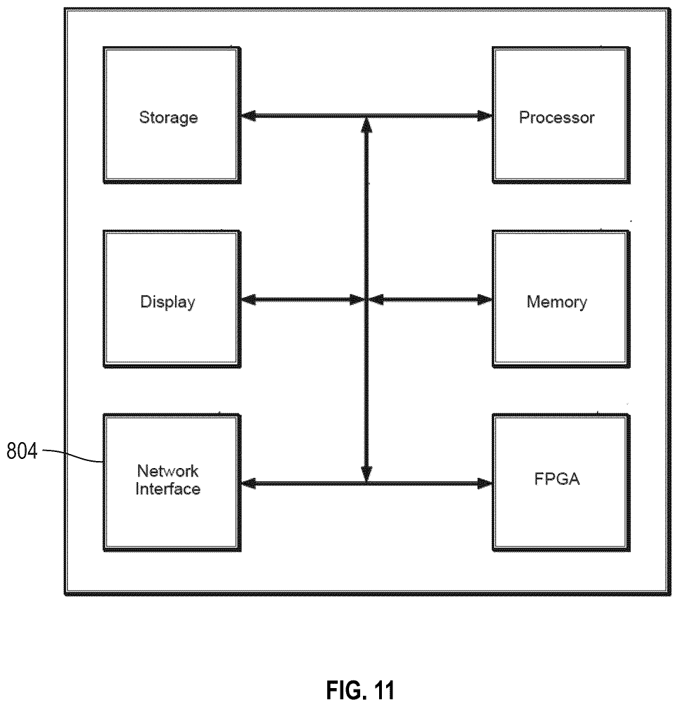

The device described in relation to FIGS. 8-13 is identical in structure, function, and operation to the device detailed in relation to FIGS. 1-7, except as specifically discussed below. FIGS. 8-13 incorporate additional features and enhancements, including a lockable reservoir 202 with a magnetic key [314] which unlocks the lockable reservoir 202, which restrict access to pills 203, particularly controlled substances, ensuring secure storage and dispensing. This distinction and others described herein provide improved security, usability, and adaptability while maintaining the core functionality of the device.

Referring now to FIGS. 8-13, a pill dispensing device 200 is disclosed, comprising a housing 201, a reservoir 202 arranged in a cavity 209 of the housing 201 to hold a plurality of pills 203, a dispenser 204 positioned adjacent to the reservoir 202, a collection chamber 205 for collecting dispensed pills 203, and a controller 206 configured to activate the dispenser 204 at predetermined times to release pills 203 to help a patient with compliance and regulate consumption of the pills 203. The device incorporates various features for medication adherence and secure dispensing of controlled substances.

The housing 201 forms the external structure of the device, enclosing and supporting the internal components, including the removably insertable reservoir 202, dispenser 204, and collection chamber 205. It may be made of a durable material, such as ABS plastic, polycarbonate, or metal, providing structural integrity and resistance to environmental factors. The housing 201 is designed to accommodate the reservoir 202, allowing for easy loading and unloading of the reservoir 202 into and out of the housing 201. When the patient has consumed all of the pills 203, the patient removes the reservoir 203 from the housing 201. The patient can then insert a new reservoir 203 which is filled with pills 203. For controlled substances, a pharmacist can refill the reservoir 203 and lock the reservoir so that the patient can't remove the pills and consume them especially when the pills have of an addictive characteristic (i.e., controlled substance).

The housing 201 may have an electronic display 212. The display 212 may be touch screen enabled so that users can program dispensing intervals, monitor the pill count, and display text notifications. An opening at the front of the housing 201 defines the access to the collection chamber 205, where dispensed pills 203 can be retrieved by the patient.

The reservoir 202 may be configured to hold multiple pills 203 and feed them sequentially into the dispenser 204 one by one. One cycle of the dispenser 204 may dispense one pill 203 or one storage container 207 containing one or more pills 203. The reservoir 202 may be straight (see FIG. 8) or serpentine in shape (see FIG. 1). The serpentine configuration optimizes storage capacity within the housing 201 while facilitating gravity-fed movement of pills 203. Both the serpentine shaped reservoir 102 and the straight configured reservoir 202 can be removably insertable into the housing 201 and secured in place.

For controlled substances, the reservoir 202 may include a locking mechanism, which prevents unauthorized access. The locking mechanism may employs a magnetic key 314, which, when placed at a designated unlocking spot 315 on the reservoir 202, disengages the locking mechanism. The reservoir 202 remains locked after closer and during handling and can only be unlocked by authorized personnel, such as pharmacists with the magnetic key 314. When the reservoir 202 is inserted into the housing 201, a magnet 316 embedded in the housing 201 aligns with the designated unlocking spot 315 on the reservoir 202, automatically unlocking the reservoir 202 to allow pills 203 to flow into the dispenser 204.

A magnet locking mechanism is discussed in relation to the straight configured reservoir 202, but it is also contemplated that other locking mechanisms may be incorporated into the serpentine or straight configured reservoir 102, 202 to prevent or detect unauthorized opening of the reservoir 102, 202. These locking mechanisms may include a mechanical combination lock that requires a specific sequence to unlock, or a key-based lock that only authorized personnel with the proper key can access. Other possibilities include a cap lock with a deterrent mechanism, similar to those used for liquor bottles in retail settings, which encases the opening of the reservoir 102 and requires a specialized tool for removal, and a twist-and-lock mechanism where the cap locks into place when twisted, potentially with visual indicators for locked and unlocked states. Additional options could involve spring-loaded locks requiring simultaneous pressing or pulling to release, electronic locks controlled by the device's controller such as 104 with access provided via passcodes or biometrics, or snap-on security seals that must be broken to access the reservoir 102, providing tamper evidence. Push-button locks that necessitate a specific button sequence to unlock, RFID or NFC-based locks that rely on preauthorized cards or devices, lever-activated locks with pins or latches for added security, and childproof safety locks like press-and-turn or squeeze-and-lift mechanisms may also be used.

For improved functionality, the reservoir 202 may also include a spring 210 at the top, which applies consistent pressure to pills 203 or storage container 207 toward the dispenser 204, ensuring reliable feeding of the pills 203 or storage container 207 into the dispenser 204. The reservoir exit 301 is designed to align precisely with the holding chamber 213 of the dispenser 204 as the dispenser 204 rotates.

The pills 203 are stored within the reservoir 202. They may be standard pharmaceutical tablets, capsules, or customized shapes designed to fit the dimensions and mechanisms of the reservoir 202 and dispenser 204.

The device may optionally employs storage vessels 207 (see FIG. 10), which are used to hold individual pills 203 or multiple pills 203 of varying shapes and sizes. These storage vessels 207 are particularly advantageous so that the pill dispensing device 200 can be used to dispense pills 203 of different shapes, dimensions, or types that might otherwise lead to misalignment or jamming during spring fed or gravity-fed dispensing within the reservoir 202. Moreover, different pills can be dispensed at once. Each storage vessel 207 may include a base portion 303 and a lid portion 304, as shown in FIG. 10, which securely encloses the pill(s) 203 to maintain the integrity of the pills. The storage vessels 207 may be configured with standardized external dimensions to slide through seamlessly within the reservoir 202, regardless of the size or shape of the pills 203 they contain. For example, the storage vessels 207 may be round. This ensures smooth feeding through the reservoir 202.

In use, pills 203 may be loaded into the storage vessels 207 by a pharmacist or caregiver. For example, a single large pill 203 or a combination of smaller pills 203 for a single dose can be placed into the base portion 303, and the lid portion 304 may be secured via a snap-fit or threaded connection. Different pills may be loaded into different storage vessels. The loaded storage vessels 207 are then arranged sequentially in the reservoir 202 in the order that the pills 203 ought to be consumed by the patient. When the dispenser 204 rotates or is traversed to dispense a storage vessel 207 or pill 203, one storage vessel 207 may be dropped into the holding chamber 213 and delivered to the collection chamber 205, where the patient retrieves the vessel and opens it. The patient accesses the enclosed pill(s) 203. This system allows for flexibility in dispensing and ensures that pill(s) 203 of varying sizes or combinations are dispensed accurately, minimizing errors and improving patient adherence to complex medication regimens.

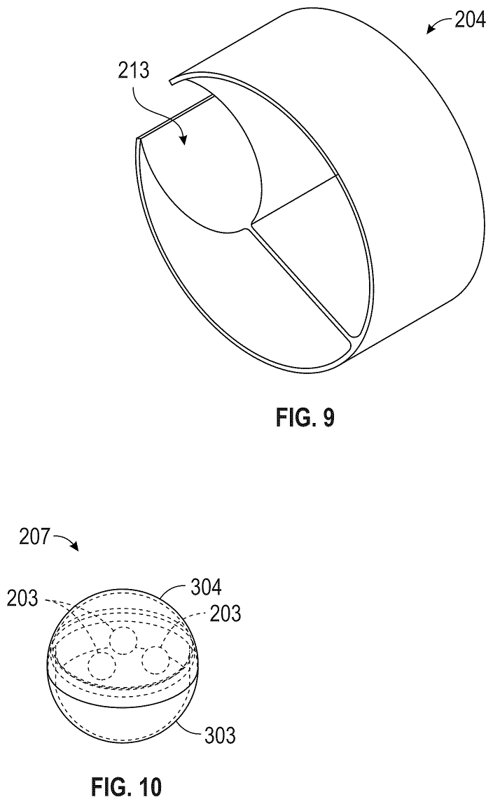

The dispenser 204 may be arranged adjacent to (i.e., below) the reservoir 202 and receives pills 203 or the storage vessel 207 for dispensing at the appropriate time. Referring to FIG. 9, the dispenser 204 includes a holding chamber 213, which collects a pill 203 or storage vessel 207 as they are released from the exit of the reservoir. A rotating mechanism 214 such as a motor rotates the dispenser 204 to move the pill 203 or storage vessel 207 from the from the exit 301 of the reservoir 102, 202 to the collection chamber 205.

The rotating mechanism 214 is configured to rotate in precise increments, allowing the release of a single pill 203 or storage vessel 207 per rotating cycle. The motor 223 is controlled by the controller 206, which dictates the timing and rotation.

The collection chamber 205 is located below the dispenser 204 and is accessible through the opening 211 in the housing 201. It is designed to catch a pill 203 or storage vessel 207 as they are dispensed.

The controller 206 governs the operation of the device, including dispensing intervals, user notifications, and security features. It may include a processor, a memory, and a circuit board, all housed on a printed circuit board within the housing 201. The processor executes instructions stored in the memory, enabling the user to program dispensing schedules via the interface on the electronic display 212 or a blue tooth connected smartphone application.

The controller 206 interfaces with the motor 214 to control the dispenser 204, the locking mechanism 221, and the speaker for an audible alarm. It may also integrate with a timekeeping module to synchronize pill dispensing with the user's schedule.

The locking mechanism secures the reservoir 202 to prevent unauthorized access to pills 203. The magnetic key, when positioned at the designated unlocking spot 315, unlocks the reservoir 202 for loading or maintenance. This feature is particularly critical for controlled substances, as it ensures that only authorized personnel, such as pharmacists, can access the pills within the reservoir 102, 202.

The pill dispensing device may incorporate a magnet 316 embedded within the housing. The magnet may be an electromagnet to regulate the dispensing of pills or storage vessels. The electromagnet provides an added layer of control by ensuring that pills or storage vessels are only released into the dispenser at designated times. In particular, when activated, the electromagnet allows the pill or storage vessel to be dispensed out of the reservoir 102, 202, allowing it to be fed into the dispenser. As the dispenser rotates, the pill or storage vessel is pushed into the holding chamber 213 of the dispenser. The dispenser continues to rotate, eventually dropping the pill or storage vessel into the collection chamber for retrieval by the user.

For an added security for controlled substances, the electromagnet can be turned on only when it is time for the patient to take their medication. At all other times, the electromagnet remains off, effectively preventing dispensing of the pill or storage vessel from the reservoir. This mechanism prevents unauthorized access, as the dispenser's rotation alone is insufficient to deliver a pill or storage vessel to the collection chamber. The activation of the electromagnet is decoupled from the operation of the dispenser. This enhances tamper resistance, particularly for controlled substances. Users cannot bypass the intended schedule by manually rotating the dispenser. If that happens, the reservoir prevents dispensing of the pill or storage vessel, ensuring that medications are dispensed strictly according to the prescribed regimen. This design offers robust security and precision, addressing the risks of misuse or accidental overdoses while maintaining ease of use for patients and caregivers.

When the reservoir 102, 202 is placed in the housing 201, an embedded magnet in the housing 201 automatically interacts with the locking mechanism 221 to unlock the reservoir 102, 202, allowing pills 203 to flow out of the reservoir 102, 202 into the dispenser 204. This dual-magnetic system ensures security during handling and seamless operation during dispensing.

The device may be powered by a rechargeable battery 217 or an AC/DC power adapter 218. The adapter 218 ensures uninterrupted operation, while the battery 217 provides portability and backup power during outages.

The device may include a speaker to provide an audible alarm and an electronic display 212 to notify users when a pill 203 has been dispensed. The display 212 provides information such as the reservoir's 202 load status, the number of pills remaining, and the next dispensing time. Referring to FIG. 12, a network interface 804 enables connectivity with external systems, such as pharmacies or doctors, for remote monitoring and notifications.

The pill dispensing device offers significant benefits for both patients and healthcare providers by addressing two critical challenges: managing complex medication regimens and controlling access to substances prone to misuse. Designed with convenience and safety in mind, the device provides a reliable solution for patients who struggle to adhere to prescribed schedules, ensuring that medications are taken at the correct times while preventing misuse of controlled substances.

For patients with complicated pill regimens involving multiple medications taken at varying intervals, the device simplifies their routine. Its programmable controller and precise dispensing mechanism ensure that the correct pills are released at the right times, reducing the burden on patients to remember complex schedules. The device also minimizes the risk of missing doses or taking medication at the wrong time, which is crucial for maintaining the efficacy of treatment plans. Additionally, features like audible alerts and a digital display provide real-time feedback, notifying users when it's time to take their pills and offering clear information about what medication is being dispensed. This combination of automated reminders and accessible data improves adherence and supports better health outcomes.

The locking mechanism integrated into the reservoir 102, 202 adds a vital layer of security for medications with high misuse potential, such as opioids or other controlled substances. By limiting access to authorized personnel, such as pharmacists or doctors, the device ensures that patients cannot access more medication than prescribed. This helps mitigate risks of addiction or overdose, providing peace of mind to both patients and their caregivers. Once the reservoir is emptied, the patient can return the empty reservoir to the pharmacist for refilling, maintaining a controlled chain of custody for the medication. This design not only reduces the likelihood of misuse but also allows healthcare providers to monitor and manage the patient's medication supply effectively.

In addition to promoting safety and compliance, the reservoir 102, 202 is refillable. The patient can return the empty reservoir 102, 202 to a pharmacist for refilling. By returning the reservoir for refilling, patients maintain a streamlined and consistent supply of medication while reducing the need for excessive packaging. The patient doesn't need to fill the reservoir 102, 202. Rather, the pharmacist can do that and ensure that the proper pills are dispensed at the right time. This collaborative approach builds trust and accountability, ensuring patients have ongoing support in managing their health. Overall, the pill dispensing device is a comprehensive solution that enhances medication adherence, safeguards against misuse, and fosters a secure, user-friendly experience for all stakeholders.

Exemplary configurations of the disclosure are described herein (e.g., with reference to the accompanying drawings). Like reference numerals may refer to like elements throughout the specification and drawings.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A dispensing clock for dispensing medication pills, comprising:
a housing;
a reservoir arranged in the housing, wherein the reservoir is configured to hold a plurality of dispensable products;
a dispenser arranged in the housing adjacent the reservoir, wherein the dispenser is configured to receive at least one dispensable product of the plurality of dispensable products from the reservoir;
a collection chamber defined in the housing, wherein the dispenser is configured to dispense the at least one dispensable product of the plurality of dispensable products received from the reservoir to the collection chamber for a user to collect the at least one dispensable product of the plurality of dispensable products; and
a controller configured to activate the dispenser at a predetermined time to dispense the at least one dispensable product of the plurality of dispensable products to the collection chamber for collection by the user;
a plurality of storage vessels including two or more portions removably coupled to each other, wherein each of the storage vessels of the plurality of storage vessels is configured to hold the at least one dispensable product of the plurality of dispensable products.

2. The dispensing clock of claim 1, wherein the dispensable product is a pill or a storage vessel.

3. The dispensing clock of claim 2, wherein the storage vessel contains one or more pills.

4. The dispensing clock of claim 1, wherein the controller is configured to dispense the dispensable product only at a predetermined time as programmed on the controller.

5. The dispensing clock of claim 1, further comprising an electromagnet controlled by a controller and arranged in the housing and configured to selectively activate for permitting release of the dispensable product from the reservoir into the dispenser only when the electromagnet is activated.

6. The dispensing clock of claim 1, further comprising a locking mechanism associated with the reservoir to restrict access to the dispensable products.

7. The dispensing clock of claim 6, wherein the locking mechanism is configured to detect tampering and generate an alert if unauthorized access is attempted.

8. The dispensing clock of claim 1, wherein the dispenser is configured to rotate to dispense an individual dispensable product from the reservoir to the collection chamber.

9. The dispensing clock of claim 1 wherein the reservoir is removably insertable into the housing.

10. A dispensing clock for dispensing medication pills, comprising:
a housing;
a reservoir arranged in the housing, wherein the reservoir is configured to hold a plurality of dispensable products;
a dispenser arranged in the housing adjacent the reservoir, wherein the dispenser is configured to receive at least one dispensable product of the plurality of dispensable products from the reservoir;
a collection chamber defined in the housing, wherein the dispenser is configured to dispense the at least one dispensable product of the plurality of dispensable products received from the reservoir to the collection chamber for a user to collect the at least one dispensable product of the plurality of dispensable products; and
a controller configured to activate the dispenser at a predetermined time to dispense the at least one dispensable product of the plurality of dispensable products to the collection chamber for collection by the user;
wherein the dispenser includes a holding chamber and an orifice configured to pass the at least one dispensable product of the plurality of dispensable products into the holding chamber from the reservoir.

11. The dispensing clock of claim 10, further comprising a motor configured to rotate the dispenser.

12. The dispensing clock of claim 10, further comprising a tamper-detection mechanism to detect unauthorized attempts to access the reservoir.

13. A method for dispensing pills using a dispensing clock, the method comprising:
providing a housing containing a reservoir configured to hold a plurality of pills;
using an unlocking mechanism in the housing to permit release of a pill from the reservoir into a dispenser upon activation of the unlocking mechanism;
traversing the dispenser to transfer the pill from the reservoir into a holding chamber of the dispenser;
further traversing the dispenser to dispense the pill from the holding chamber into a collection chamber for retrieval by a user;
deactivating the unlocking mechanism, thereby preventing pills from being removed from the reservoir despite traversal of the dispenser; and
controlling the activation and deactivation of the electromagnet separately from traversal of the dispenser using a controller programmed to adhere to a predetermined dispensing schedule.

14. The method of claim 13, wherein the locking mechanism is an electromagnet and deactivating the locking mechanism comprising activating the electromagnet.

15. The method of claim 13, further comprising:
notifying the user via a connected mobile device when a pill is ready to be collected.

16. The method of claim 13, further comprising a wireless connection to the dispensing clock so that a third party can program a pill dispensing regimen.

17. The method of claim 13 further comprising removal of the reservoir from the housing for delivery to a pharmacist to refill the empty reservoir and insertion of a filled reservoir.

18. The method of claim 13, further comprising:
detecting whether the reservoir is empty and notifying the user or a caregiver that refilling is required.

19. The method of claim 13, further comprising:
using a tamper-detection mechanism to monitor unauthorized attempts to rotate the dispenser or access the reservoir and generating an alert if tampering is detected.

20. The method of claim 13, further comprising:
customizing the dispensing schedule based on user input or changes in prescription requirements.
